(19) United States
(12) Patent Application Publication
(10) Pub. No.: US 2005/0237587 A1
(43) Pub. Date: Oct. 27, 2005

(54) Image processing system, image display apparatus, printer, and printing method

(75) Inventor: Yasuhiro Nakamura, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/107,933

(22) Filed: Apr. 18, 2005

(30) Foreign Application Priority Data
Apr. 22, 2004 (JP) 2004-126933

(51) Int. Cl. G06F 15/00

(52) U.S. Cl. 358/527

(57) ABSTRACT

Exemplary embodiments of the invention provide an image processing system, an image display apparatus, a printer, and a printing method that are capable of, when a user attempts to print-output image data, adjusting an orientation of printing of the image data and an orientation of a print sheet to an appropriate direction to print-output the image data on the print sheet. According to exemplary embodiments, an image display apparatus includes a display device and a display control unit that controls to display an image on the display device on the basis of image data to be inputted. A printer includes a printing unit that outputs an image based on the image data to a print medium and an image upper side judging unit that, in printing the image displayed on the display device, judges the top and the bottom of the image on the basis of additional information included in image data of the image. The printer rotates the image such that an upper side of the image and an upper side of the print media defined by the printer coincide with each other on the basis of a result of the judgment by the image upper side judging unit and outputs the image to the printing unit.

### BACKGROUND

Exemplary embodiments of the present invention relate to an image processing system including an image display apparatus that performs image processing for image data and a printer that outputs the image data to a print medium, the image display apparatus, the printer, and a printing method.

The related art includes image processing and printing apparatuses which can store and print television images, DVD (Digital Versatile Disc) reproduction images, and images photographed by video cameras. The related art includes as these types of apparatuses, for example, television receivers and DVD reproduction apparatuses, which have video printer and video input functions.

With respect to television receivers, related art document JP-A-9-121313 discloses a television receiver that converts a video signal into image data and stores the image data in a video memory device one after another. Further, the receivers, when a print output instruction is inputted by a print button from a remote controller, print-outputs the image data, which is read out from the video memory device, from a printer device and displays information, which indicates that print-output is being performed, on a television screen.

Related art document JP-2000-293340 discloses an image processing apparatus that, when print information of an image selected by an image selecting device is created, can simplify operation at the time of print designation by reading out additional information of the selected image with an additional information readout device and, if specific additional information is included in the additional information of the read-out image, adding the specific additional information to the print information.

### SUMMARY

In the related art techniques, when a user attempts to print-output an image photographed by a video camera or a video displayed on a television screen, rotation information (upper side position information of a digital camera) of the image is not added to image data in some cases. When the user changes image data by rotation or the like of the image, for example, a long side of the image and a long side of a print sheet do not coincide with each other or the image is printed upside down in some cases.

Thus, exemplary embodiments of the invention have been devised in view of the points described above. It is an object of exemplary embodiments of the invention to provide an image processing system, an image display apparatus, a printer, and a printing method that are capable of, when a user attempts to print-output image data, adjusting an orientation of printing of the image data and an orientation of a print sheet to an appropriate direction to print-output the image data on the print sheet.

In order to address and/or solve the above discussed and/or other problems, an image processing system of exemplary embodiments of the invention is an image processing system including an image display apparatus that performs image processing for image data and a printer that outputs an image based on the image data to a print medium. The image display apparatus includes a display unit that displays an image; and a first image control unit that creates image data for printing to be outputted to the printer. The printer includes a second image control unit; and a printing unit, and, in printing the image displayed on the display unit, the image processing system sets an orientation of the image to be printed such that the orientation is appropriate with respect to an orientation of the print medium defined by the printer.

According to the image processing system, when the image displayed on the image display apparatus is printed, an orientation of the image to be printed is set appropriate with respect to an orientation of the print medium defined by the printer. Thus, it is possible to print the image data while reducing or preventing, for example, the image from lying off the print medium or being printed upside down.

The image processing system of exemplary embodiments of the invention is characterized in that the image data is inputted from the outside and, when orientation information is added to the image data, a reference of the orientation of the image to be printed is set as the orientation information.

According to the image processing system, when orientation information is added to image data, by setting a reference of an orientation of an image to be printed as an orientation of a print medium defined by the printer, it is possible to print the image data while reducing or preventing, for example, the image from lying off the print medium or being printed upside down.

The image processing system of exemplary embodiments of the invention is characterized in that the reference of the orientation of the image to be printed is set as the orientation of the image displayed on the display unit.

According to the image processing system, when orientation information is not added to image data, by setting a reference of an orientation of an image to be printed as an orientation of an image displayed on the display unit, it is possible to print the image while reducing or preventing, for example, the image from lying off a print medium or being printed upside down.

The image processing system of exemplary embodiments of the invention is characterized in that the image data is inputted from the outside and, when orientation information added to the image data and the orientation of the image displayed on the display unit do not coincide with each other, the orientation of the image, which is displayed on the display unit, is preferentially used as the reference of the orientation of the image to be printed.

According to the image processing system, when orientation information added to image data and an orientation of an image displayed on the display unit do not coincide with each other, the orientation of the image, which is displayed on the display unit, is preferentially used as a reference of an orientation of an image to be printed. Thus, the image can be printed without lying off a print sheet.

The image processing system of exemplary embodiments of the invention is characterized in that the first image control unit adds additional information, with which the printer recognizes the orientation of the image to be printed, to the image data for printing. The second image control unit adjusts the orientation of the image to be printed on the basis of the additional information added to the image data for printing and causes the printing unit to print the image.

According to the image processing system, the image display apparatus includes the first image control unit that adds additional information, with which the printer recognizes an orientation of an image to be printed, to image data for printing. The printer includes the second image control unit that adjusts an orientation of the image to be printed on the basis of the additional information added to the image data for printing and causes the printing unit to print the image. Thus, the image processing system may be applied to an image display apparatus with a printer or may be applied to an image display apparatus and a printer that are separately provided. Note that, when the image display apparatus and the printer are separately provided, it is possible to connect the image display apparatus and the printer with a communication cable or the like (or by radio).

The image processing system of exemplary embodiments of the invention is characterized in that, when orientation information is added to the image data and the orientation information and the orientation of the image displayed on the image display unit do not coincide with each other, the first image control unit replaces the orientation information with a content suited to the orientation of the image displayed on the display unit and creates image data for printing.

According to the image processing system, when orientation information added to image data and an orientation of an image displayed on the display unit do not coincide with each other because, for example, a user changes the orientation of the image data, the first image control unit replaces the orientation information added to the image data with a content suited to the orientation of the image displayed on the display unit and creates image data for printing. Thus, the image, the orientation of the image data of which is changed by the user, can be printed without lying off a print sheet.

The image processing system of exemplary embodiments of the invention is characterized in that the first image control unit changes the orientation of the image data such that the orientation of the image to be printed is appropriate with respect to the orientation of the print medium defined by the printer and creates image data for printing.

According to the image processing system, the image control unit of the image display apparatus changes an orientation of image data such that an orientation of an image to be printed is appropriate with respect to an orientation of a print medium defined by the printer and sends the image data to the printer. Thus, it is possible to simplify a structure of the printer.

The image processing system of exemplary embodiments of the invention is characterized in that the second image control unit arranges an image such that a shape of the image to be printed and a shape of the print medium coincide with each other and adjusts the orientation of the image to be printed on the basis of the image data for printing to cause the printing unit to print the image.

According to the image processing system, the second image control unit on the printer side arranges an image such that a shape of an image to be printed and a shape of the print medium coincide with each other and adjusts an orientation of the image to be printed on the basis of image data for printing to cause the printing unit to print the image. Thus, it is possible to print the image data while reducing or preventing, for example, the image from lying off the print medium or being printed upside down.

The image processing system of exemplary embodiments of the invention is characterized in that, when the image is arranged such that a long side of the image is set along a long side of the print medium, if a top-to-bottom direction of the image based on the image data for printing and a print direction coincide with each other, the second image control unit rotates the image such that the long side of the image is set along the long side of the print medium and an upper side of the print medium defined by the printer and an upper side of the image coincide with each other and causes the printing unit to print the image.

According to the image processing system, when an image is arranged such that a long side of the image is set along a long side of a print medium, if a top-to-bottom direction of the image and a print direction coincide with each other, the second image control unit rotates the image such that the long side of the image is set along the long side of the print medium and an upper side of the print medium defined by the printer and an upper side of the image coincide with each other. Thus, it is possible to print image data while reducing or preventing the image from lying off the image medium or being printed upside down. This is particularly effective, for example, in setting an orientation of an address and an orientation of an image in the same direction when image data is printed on a postcard. Thus, it is also possible to reduce or prevent wasteful use of print media.

The image display apparatus constituting the image processing system of exemplary embodiments of the invention is characterized by including the display unit and the first image control unit.

According to the image display apparatus, the first image control unit and the display unit are provided on the image display apparatus side. Thus, it is possible to simplify a structure of the printer.

The printer constituting the image processing system of exemplary embodiments of the invention is characterized by including the second image control unit and the printing unit.

According to the printer, since the second image control unit and the printing unit are provided in the printer, the printer arranges an image such that a shape of an image to be printed and a shape of the print medium coincide with each other and adjusts an orientation of the image to be printed on the basis of image data for printing to cause the printing unit to print the image. Thus, it is possible to connect the printer and various display devices easily.

A printing method for the printer constituting the image processing system of exemplary embodiments of the invention is characterized by including: recognizing an orientation of the print medium defined by the printer; recognizing an orientation of an image based on image data; adjusting an orientation of an image to be printed such that the orientation of the image to be printed is appropriate with respect to the orientation of the print medium defined by the printer; and outputting the image to the print medium in the adjusted orientation.

According to the printing method, the printer arranges an image such that a shape of an image to be printed and a shape of the print medium coincide with each other and adjusts an orientation of the image to be printed on the basis of image data for printing to cause the printing unit to print the image. Thus, it is possible to print image data while reducing or preventing the image from lying off the print medium or being printed upside down.

### BRIEF DESCRIPTION OF THE DRAWINGS

FIG. 1 is a schematic showing a structure of an image processing system of exemplary embodiments of the invention;

FIGS. 2A-C are schematics showing an example of header information in print data;

FIG. 3 is a schematic showing a display screen that is displayed on a display device;

FIGS. 4A-B are schematics showing a printing method at the time when rotation information is added;

FIGS. 5A-B are schematics showing a printing method at the time when rotation information is not added;

FIG. 6 is a schematic showing a printing method at the time when rotation instructing information is added;

FIG. 7 is a flowchart showing a processing procedure of image processing of an image display apparatus;

FIG. 8 is a flowchart of a print processing operation of a printer;

FIG. 9 is a schematic showing a structure of an image display system according to a second exemplary embodiment; and

FIG. 10 is a schematic showing a display screen in capture operation.

### DETAILED DESCRIPTION OF EMBODIMENTS

### First Exemplary Embodiment

A first exemplary embodiment embodying the invention will be hereinafter explained.

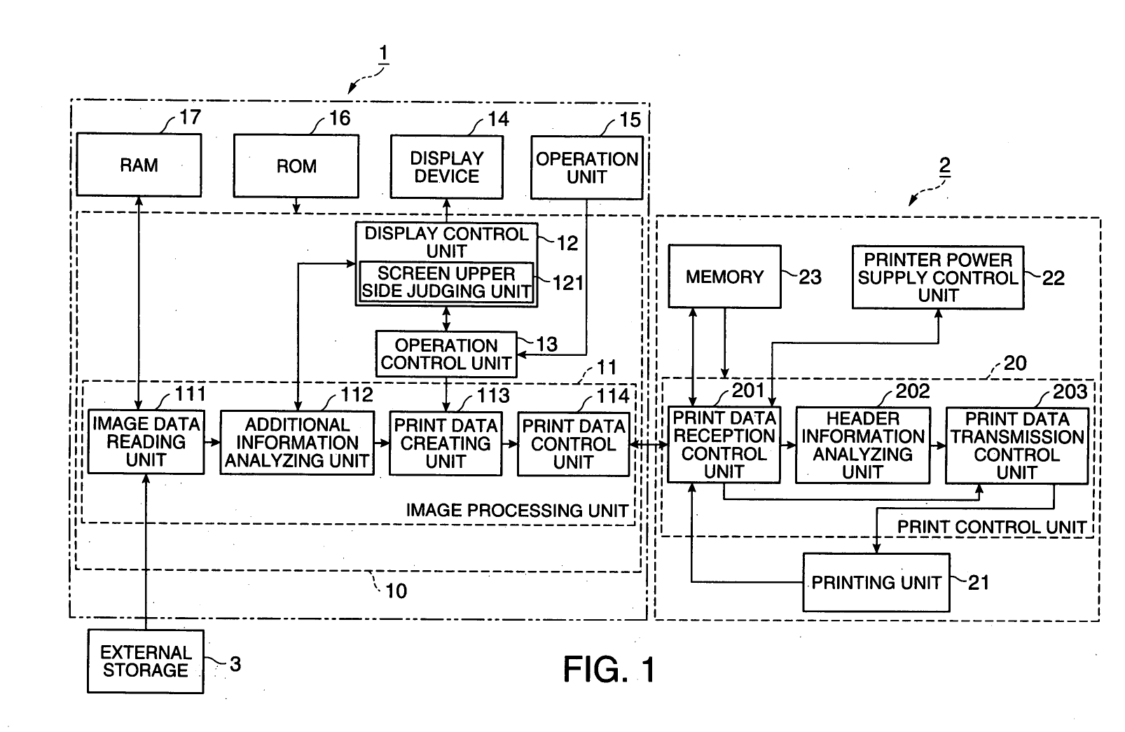

FIG. 1 is a schematic showing a structure of an image processing system of exemplary embodiments of the invention.

In FIG. 1, the image processing system includes an image display apparatus 1, a printer 2 serving as a printing apparatus, and an external storage 3. Note that it is possible to connect various drive devices such as a CD-R/RW (Compact Disk Recordable/ReWritable), a DVD, and an HD (Hard Disk), a digital camera, a notebook PC (Personal Computer), or a reader writer device for various card media storing image data of the digital cameral or the like to the external storage 3.

The image display apparatus 1 includes a CPU (Central Processing Unit) 10, a display device 14, an operation unit 15, a ROM 16, and a RAM 17. Note that, when the CPU 10 executes a control program and various application programs stored in the ROM 16, an image processing unit 11 serving as a first image control unit, a display control unit 12, and an operation control unit 13 are established. It is possible to use various display devices such as a projector, a CRT (Cathode-Ray Tube) as the display device 14.

The image processing unit 11 includes an image data reading unit 111 that reads image data in the external storage 3, an additional information analyzing unit 112 that analyzes information added to the image data read by the image data reading unit 111 and reflects a result of the analysis on display and printing. A print data creating unit 113 receives the result of the analysis by the additional information analyzing unit 112 and creates print information serving as image data for printing obtained by adding header information to image data to be printed. A print data control unit 114 outputs the print information created in the print data creating unit 113 to the printer 2 and monitors a status of the printer 2.

For example, in the case of image data photographed by a digital camera, the information added to the image data read by the image data reading unit 111 is photographing property information such as a photographing date and time and rotation information of an image (upper side position information of the digital camera). The rotation information of this photographing property information is different depending on a type of digital camera and is not added in some digital cameras.

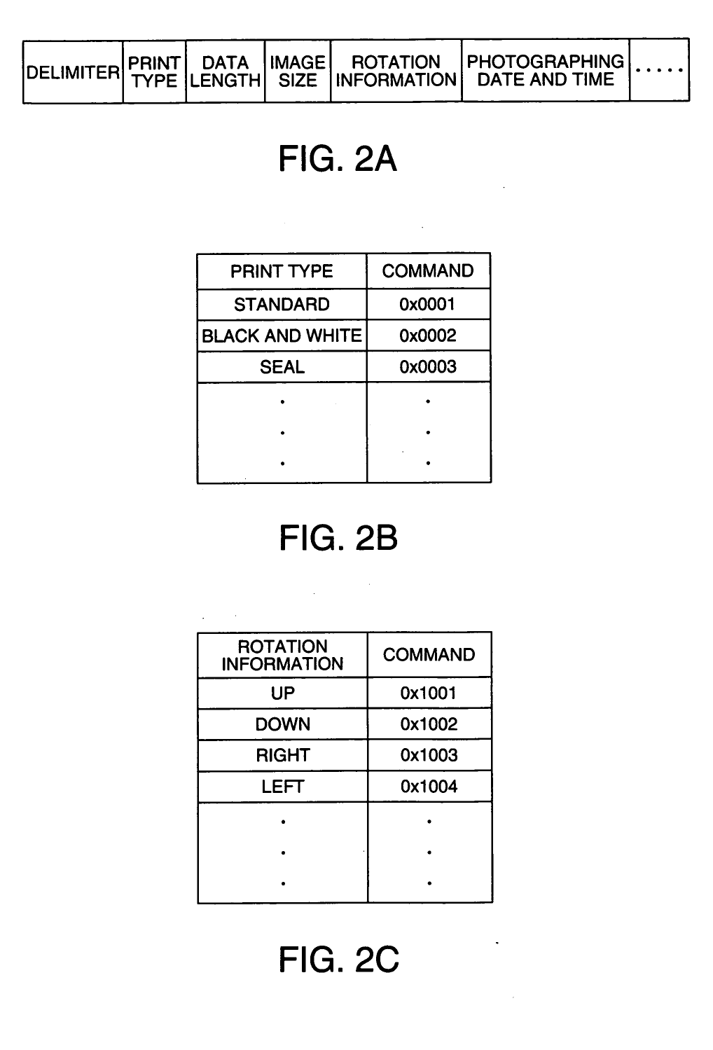

FIGS. 2A-C show the header information in the print information created by the print data creating unit 1 13. FIG. 2A shows a schematic structure of the header information. The figure shows information such as a delimiter, a print type, a data length, an image size, rotation information, and a photographing date and time that are necessary for printing. A command is allocated to each piece of information of this header information for each set item. For example, FIG. 2B shows an example of commands for print types and FIG. 2C shows an example of commands for rotation information. Note that up, down, right, and left of the rotation information indicate to which side an upper side position of the digital camera or an upper side position of an image, which a user instructs to rotate, is set with respect to an orientation at the time when image data is recognized by a usual method.

The display control unit 12 includes an image upper side judging unit 121 and receives the result of the analysis on the image data by the additional information analyzing unit 112 to control a video signal and image data to be displayed on the display device 14. The image upper side judging unit 121 judges an image upper side of the image data to be displayed on the display device 14. For example, in general, an aspect ratio of image data photographed by a digital camera is 3 (a vertical or short side): 4 (a horizontal or long side). In the judgment on the image upper side, the image upper side judging unit 121 judges in which of up, down, right, and left of the rotation information the image upper side is located and whether the image upper side is a short side or a long side. A result of this judgment is inputted to the print data creating unit 113 via the additional information analyzing unit 112 and written in print information, which is created by the print data creating unit 113, as the rotation information of the header information.

The operation control unit 13 controls a rotation instruction or the like, for an image on the basis of operation of an operation key in the operation unit 15 and outputs control data to the display control unit 12.

The display device 14 performs index display, print preview display, and the like to be described later on the basis of control for image data by the display control unit 12.

The control unit 15 includes various operation keys (all of which are not shown) for example [Enter] and [Exit] keys, [Up], [Down], [Right], and [Left] keys for performing operation such as index display, [R. Rotate] and [L, Rotate] keys for instructing rotation, and [Print], [Execute Printing], and [Trimming] keys for performing operation for print preview display. The operation unit 15 can perform various kinds of display operation according to predetermined operation of the respective keys or issue a rotation instruction according to which a user rotates a displayed image (image data) (give rotation instructing information), as required. The operation for the index display and the print preview display is performed on respective display screens displayed on the display device 14.

As the rotation instructing information of a displayed image (image data) operated by the operation unit 15, the image upper side judging unit 121 of the display control unit 12, writes rotation information on an image before a rotation instruction and judging information on an upper side of the image, which indicates whether an image upper side of the image data is a short side or a long side, in the header information, which is created by the print data creating unit 113, via the additional information analyzing unit 112, as a part of the rotation information. Note that, when rotation information (upper side position information of the digital camera) is added to the original image (the image before the rotation instruction), the rotation instructing information takes priority over the rotation information.

The ROM (Read-Only Memory) 16 stores a control program to control the respective units of the image display apparatus 1 and various application programs. When the CPU 10 executes the control program and the various application programs stored in the ROM 16, the image processing unit 11, the display control unit 12, and the operation control unit 13 are established.

The RAM (Random Access Memory) 17 temporarily stores image data read by the image data reading unit 111.

The printer 2 is a printer having a print aspect ratio of 3 (a vertical or short side): 4 (a horizontal or long side). The printer 2 includes a print control unit 20 serving as a second image control unit, a printing unit 21, a printer power supply control unit 22, and a memory 23. The printer 2 uses cut paper as a print sheet serving as a print medium and performs printing with, for example, a short side of the print sheet set on an upstream side (up) in a printing direction.

As the print sheet, for example, an L size (size 89×127 mm) or a 2L size (size 127×178 mm) for a photograph, a postcard (size 105×148 mm, so-called A6 size), or the like, is used. In particular, in printing an image on the postcard, the image is printed on a rear surface (a print surface) of an address surface, on which characters of an address and the like of a destination are printed, with a zip code column and a stamp attaching column, which are printed in advance on an address side, set on an upstream side (up) in a printing direction and a top of the image to be printed fit on the upstream side in the printing direction.

The print control unit 20 is a CPU. When the CPU 20 executes the control program and the various application programs stored in the memory (ROM) 23, a print data reception control unit 201, a header information analyzing unit 202, and a print data transmission control unit 203 are established and the CPU 20 controls print information transmitted from the image display apparatus 1.

The print data reception control unit 201 receives print information transmitted from the print data control unit 114 of the image display apparatus 1 and outputs the print information to the header information analyzing unit 202. In addition, the print data reception control unit 201 periodically acquires (receives) status information (standby, printing, error, and print end) of the printing unit 21. When the status information of the printing unit 21 indicates an error, the print data reception control unit 201 performs control for outputting the information to the print data control unit 114 of the image display apparatus 1 and the print data transmission control unit.

The header information analyzing unit 202 analyzes header information added to the print information inputted from the print data reception control unit 201, generates print data, which is obtained by applying rotation processing to image data, on the basis of the print information, and outputs the generated print data to the print data transmission control unit 203.

The print data transmission control unit 203 outputs the print data inputted from the header information analyzing unit 202 to the printing unit 21. The print data transmission control unit 203 outputs the print data to the printing unit 21 only when the printing unit 21 is in the standby state. When the printing unit 21 is in the printing or error state, the print data transmission control unit 203 performs control for putting the printing unit 21 on standby without outputting the print data.

The printing unit 21 prints the image data, which is based on the header information of the header information analyzing unit, on a print sheet. When rotation information on the image data is included in the header information, the printing unit 21 rotates the image data on the basis of the header information and prints the image data. In addition, the printing unit 21 periodically outputs the status information (standby, printing, error, and print end) of the printing unit 21 to the print data reception control unit 201.

The printer power supply control unit 22 controls a printer power supply. Power is preferably always supplied to the print data reception control unit 201 but is not always supplied to the other units to save power consumption. When the printer power supply control unit 22 receives a signal, which indicates the input of the print data from the print data control unit 114 of the image display apparatus 1, from the print data reception control unit 201, the printer power supply control unit 22 turns ON power supply to the entire printer 2. When the printer power supply control unit 22 receives the status information indicating print end of the printing unit 21, which is received by the print data reception control unit 201 from the printing unit 21, from the print data reception control unit 201, the printer power supply control unit 22 turns OFF power supply to the unnecessary units of the printer 2.

The memory 23 includes a ROM and stores a control program to control the respective units of the printer 2 and various application programs.

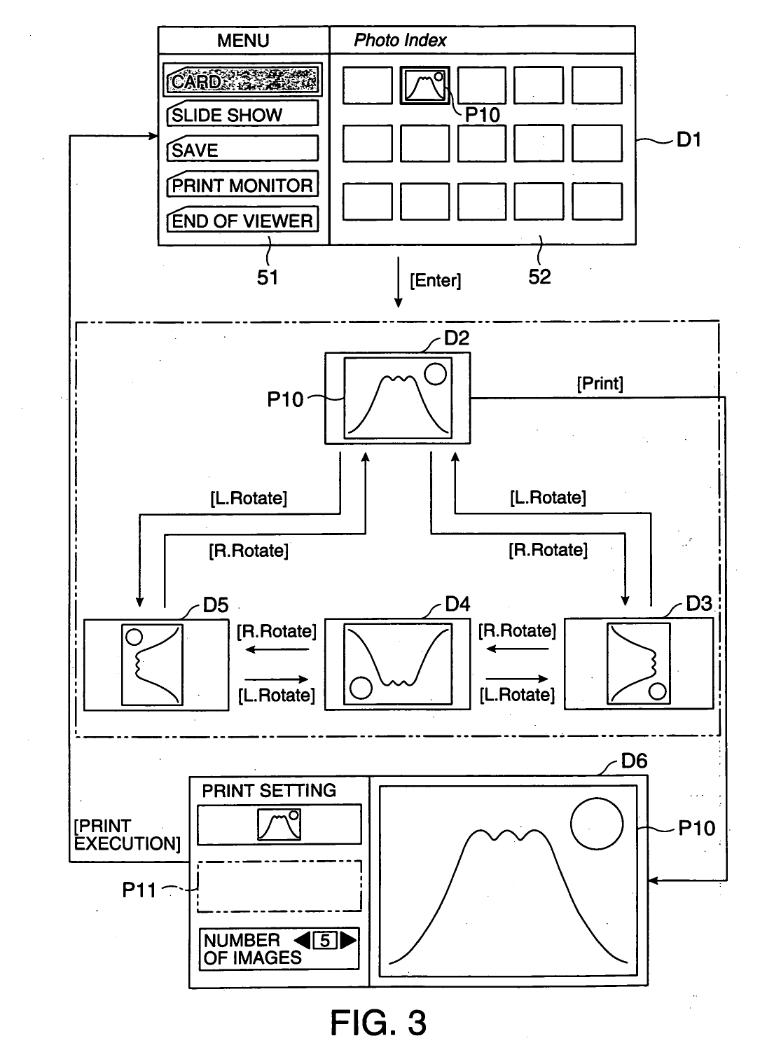

Next, FIG. 3 is a schematic showing an example of a display screen that is displayed on the display device 14.

A display screen D1 is an index display screen for an image obtained by analyzing, in the additional information analyzing unit 112, additional information of image data, which is, for example, photographed by a digital camera, read from the external storage 3 by the image data reading unit 111. The display screen D1 includes a menu screen 51 and an index screen 52.

When a user selects, for example, an image P10 among images on the index screen 52 and operates (depresses) the [Enter] key of the operation unit 15, the selected image P10 is displayed on a screen of the display device 14 in enlargement (a display screen D2). At this point, when rotation information is added to the image, the image P10 is displayed such that a side set as an upper side is at the top on the basis of the rotation information. When rotation information is not added, the image P10 is displayed in an orientation at the time when the image data is recognized by a usual method. Note that, in the stage of the index display screen, that is, the display screen D1, each image may be displayed such that a side set as an upper side is at the top on the basis of rotation information added to the image.

When the user operates the [R, Rotate] key of the operation unit 15 in a display state of the display screen D2, the image P10 rotates to the right by 90 degrees and the display state changes to a display state of a display screen D3. After that, every time the user operates the [R, Rotate] key, the image P10 rotates to the right by 90 degrees and shifts to a display screen D4, a display screen D5, and a display screen D2.

When the user operates the [L, Rotate] key of the operation unit 15 in the display state of the display screen D2, the image P10 rotates to the left by 90 degrees and the display state changes to the display state of the display screen D5. After that, every time the user operates the [L, Rotate] key, the image P10 rotates to the left by 90 degrees and shifts to the display screen D4, the display screen D3, and the display screen D2. Information on an upper side of an image of the display screen, which is displayed by last operation of the [R, Rotate] key or the [L, Rotate] key, is added as rotation instructing information.

For example, in printing the image P10 on the display screen D2, when the user operates the [Print] key of the operation unit 15 to select the image P10 in the display state of the display screen D2, the image P10 shifts to print preview display shown in a display screen D6. Then, the user operates the [Print execution] key of the operation unit 15 in the display state of the display screen D6, the printer 2 prints the image on a print sheet.

While the image is printed, status information indicating printing is displayed in a status display area P11 (indicated by an alternate long and two short dashes line) of the printer. Note that, when the printer is in an error state, status information indicating the error is displayed in the status display area P11. When the printer 2 ends the printing of the image, the display screen returns to the index display screen (the display screen D1). The operation control unit 13 or the display control unit 12 executes the processing (see FIG. 1).

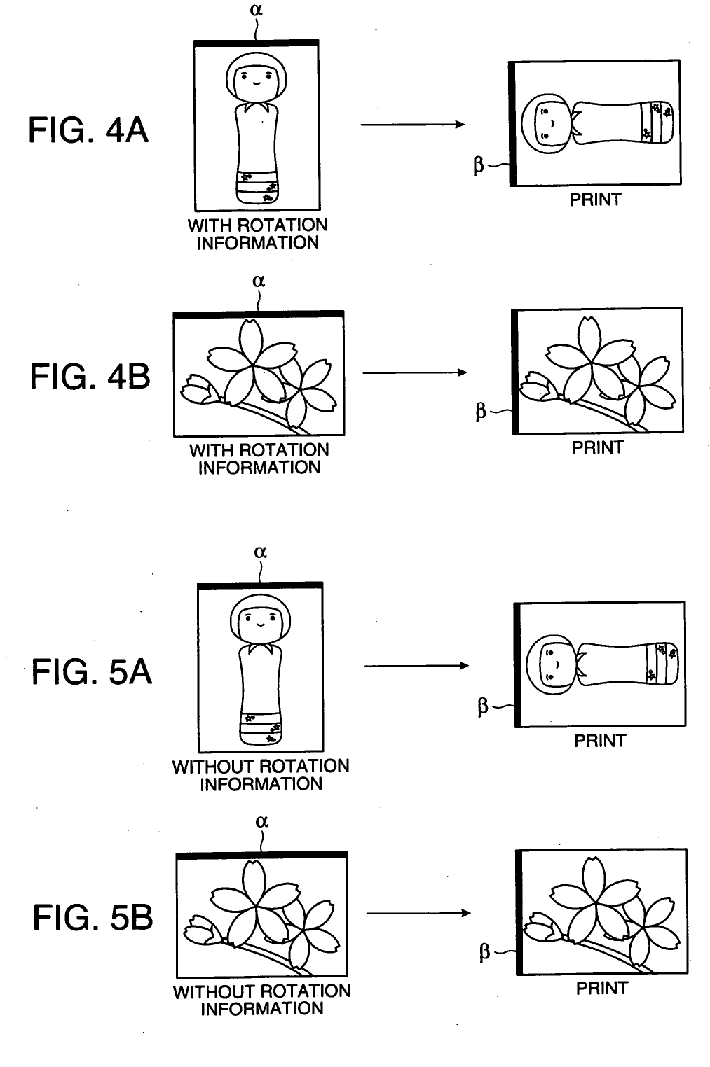

Next, a printing method for image data in the printing unit 21 will be explained based on FIGS. 4 to 6. Note that, in the respective figures, a side α of a displayed image indicates an upper side of the image data and a side β indicates a side on an upstream side (an upper side) of a print sheet at the time of printing of the image.

FIGS. 4A-B are schematics showing a printing method at the time when rotation information (upper side position information of a digital camera) is added to image data. As shown in FIG. 4A, in the case of a vertically long image in which the side α is set as the upper side and the side α is a short side, the printing unit 21 rotates the image data in a direction in which the side α is set along the side β and prints the image with the side β set on the upstream side. On the other hand, as shown in FIG. 4B, in the case of a horizontally long image in which the side α is set as the upper side and the side α is a long side, the printing unit 21 does not rotate the image data and prints the image with the side β set on the upstream side.

FIGS. 5A-B are schematics showing a printing method at the time when rotation information is not added to image data. When rotation information is not added to image data, the printing unit 21 judges that an upper side of a displayed image is an upper side of the image data. As shown in FIG. 5A, in the case of a vertically long image in which the side α is a short side, the printing unit 21 rotates the image data in a direction in which the side α is set along the side β and prints the image with the side β set on the upstream side. On the other hand, as shown in FIG. 5B, in the case of a horizontally long image in which the side a is a long side, the printing unit 21 does not rotate the image data and prints the image with the side β set on the upstream side.

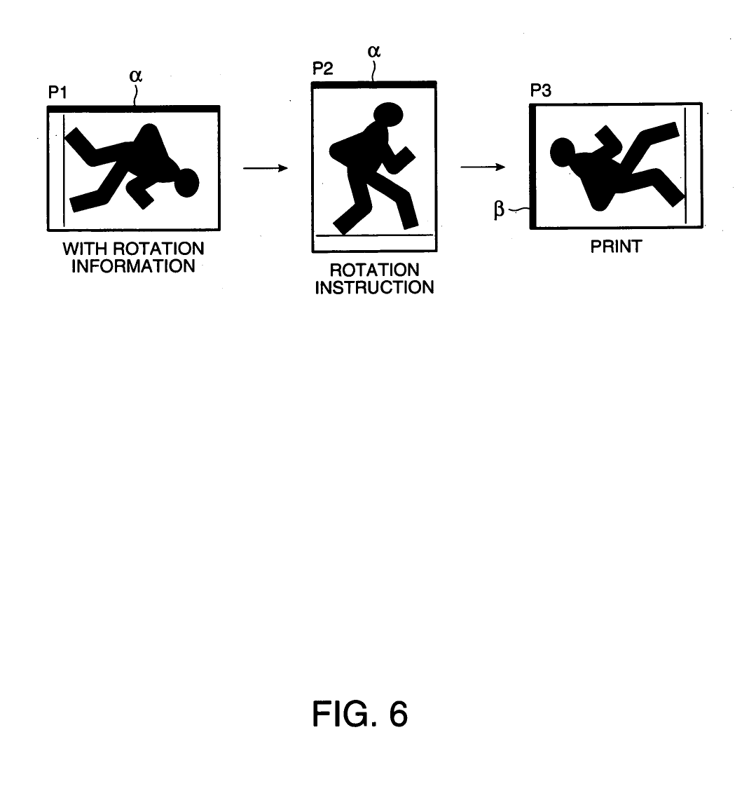

FIG. 6 is a schematic showing a printing method at the time when rotation instructing information is added to image data. Image data P1 is a horizontally long image in which the side α is set as the upper side in rotation information (upper side position information of a digital camera). Therefore, when the image is displayed, the image is displayed such that the side α is at the top as shown in the figure. When rotation is not instructed in a state in which the image is displayed, the image is printed as shown in FIG. 4B. On the other hand, when the image data P1 is rotated to the left according to operation of the [L-Rotate] key of the operation unit 15, rotation instruction information, which indicates that the side α of rotated image data P2 is set as an upper side, is added. In other words, when the rotation instructing information is added, the rotation instructing information is set as new rotation information replacing rotation information before the rotation instructing information is added. Then, according to operation of the [Print execution] key, the image data P2 is rotated to the left in a direction in which the side α of the image data P2 is set along the side β shown in image data P3 and prints the image with the side β set on the upstream side.

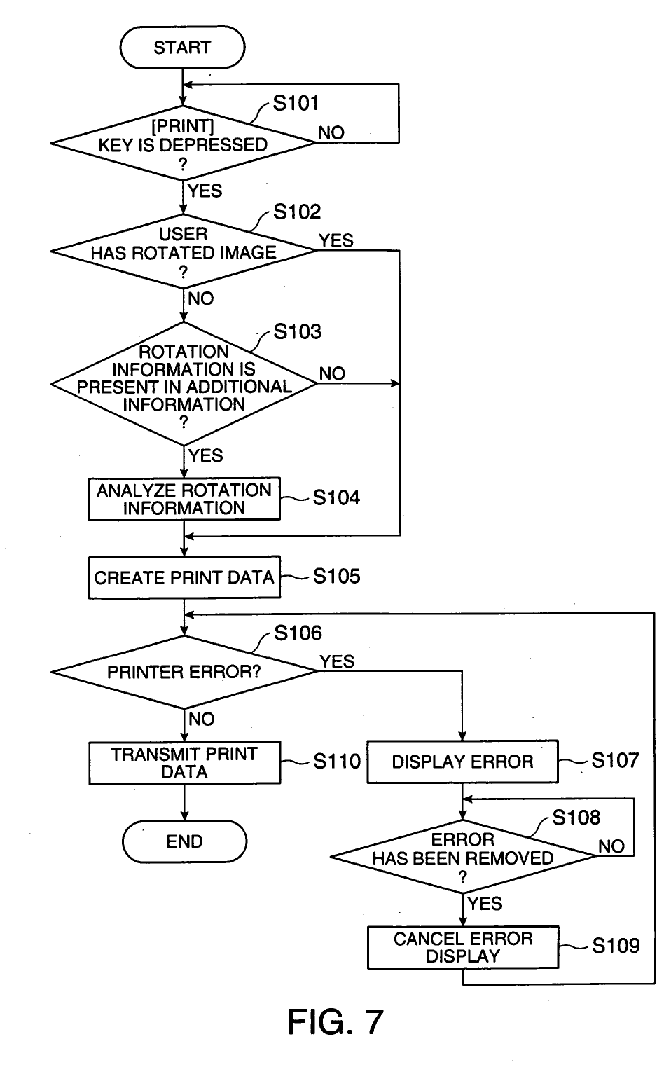

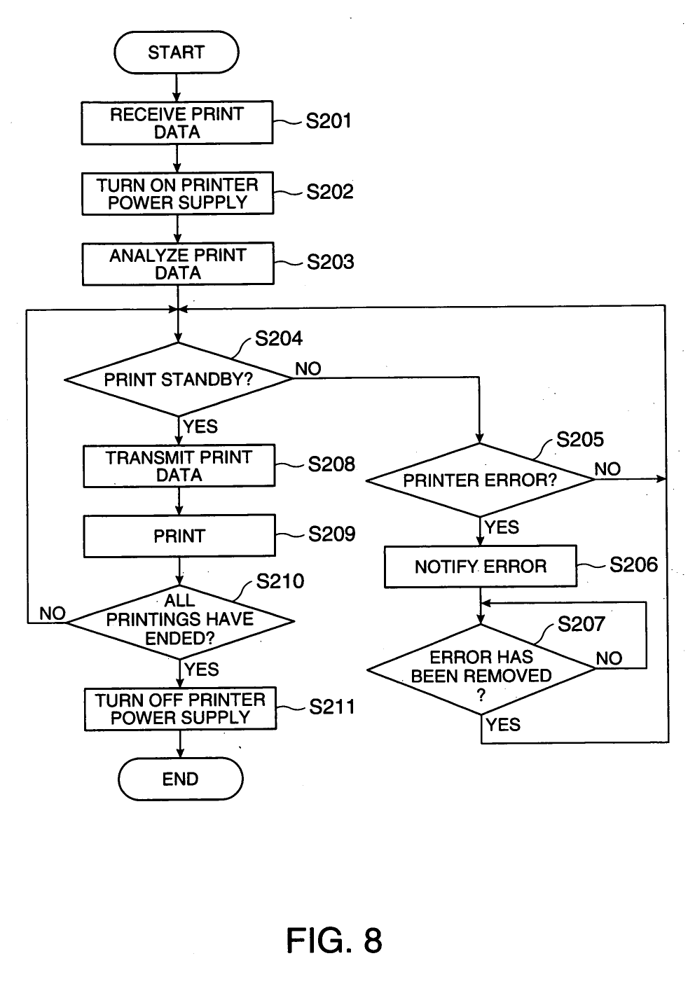

Next, an operation of the image processing system will be explained. FIG. 7 is a flowchart showing a processing procedure of image processing of the image display apparatus 1. FIG. 8 is a flowchart of a print processing operation of the printer 2.

The image processing of the image display apparatus 1 shown in FIG. 7 is executed from a state in which a reader writer device is connected to the image display apparatus 1 as the external storage 3, a card medium storing a still image photographed by a digital camera or the like is inserted (readably set) in the reader writer device, image data stored in the card medium is read by the image data reading unit 111, and a predetermined image is selected.

First, in step S101, the image display apparatus 1 judges whether the [Print] key of the operation unit 15 is operated (depressed). When the [Print] key is depressed, the image display apparatus shifts to step S102. When the [Print] key is not depressed, the image display apparatus returns to step S101. In step S 102, the image display apparatus 1 judges whether a user has rotated an image (rotation instructing information is present). When the user has rotated the image, the image display apparatus 1 shifts to step S105. When the user has not rotated the image, the image display apparatus 1 shifts to step S103.

In step S103, the image display apparatus 1 judges whether rotation information is present (rotation information is added). When the rotation information is added, the image display apparatus 1 shifts to step S104. When the rotation information is not added, the image display apparatus 1 shifts to step S105. In step S104, the image display apparatus 1 analyzes the rotation information on the basis of judgment information on an upper side of the image, which indicates whether an image upper side of image data judged by the image upper side judging unit 121 is a short side or a long side, and shifts to step S 105.

Steps S102 to S104 described above are executed in the additional information analyzing unit 112 (see FIG. 1).

In step S 105, the print data creating unit 113 adds header information necessary for printing to the image data to be printed and creates print information. Then, the image display apparatus 1 shifts to step S106. In step S106, the image display apparatus 1 judges whether a status of the printer 2 (printing unit 21), which is monitored by the print data control unit 114, indicates an error. When the status indicates an error, the image display apparatus 1 shifts to step S107. When the status does not indicate an error, the image display apparatus 1 shifts to step S110. Note that the error (a print error) refers to a state of print suspension due to lack of a print sheet, lack of an ink, print paper jam, or the like during a print operation.

In step S107, the display control unit 12 displays information on the status indicating an error on the print preview display screen (the status display area P11, see FIG. 3) of the display device 14. Then, the image display apparatus 1 shifts to step S108. In step S108, the image display apparatus 1 judges whether the error has been removed (addressed or coped with). When the error has been removed, the image display apparatus 1 shifts to step S109. When the error has not been removed, the image display apparatus 1 returns to step S108. In step S 109, the display control unit 12 cancels the display of the information on the status indicating an error on the print preview display screen of the display device 14 (turns off the status display). Then, the image display apparatus 1 returns to step S106.

In step S110, the image display apparatus 1 transmits print information from the print data control unit 114 to the printer 2 and ends the image processing.

In a print processing operation of the printer 2 shown in FIG. 8, when the printer data reception control unit 201 receives print information from the image display apparatus 1 (the print data control unit 114) in step S201, the printer 2 shifts to step S202. In step S202, the printer power supply control unit 22 outputs the print information to the header information analyzing unit 202 and turns ON power supply for the entire printer 2. Then, the printer 2 shifts to step S203. In step S203, the header information analyzing unit 202 analyzes header information added to the print information inputted from the print data reception control unit 201. The printer 2 generates print data obtained by applying rotation processing to image data on the basis of the print information, outputs the generated print data to the print data transmission control unit 203, and shifts to step S204.

In step S204, the print data reception control unit 201 judges whether the printing unit 21 is on standby on the basis of status information of the printing unit 21. If the printing unit 21 is not on standby, the printer 2 shifts to step S205. If the printing unit 21 is on standby, the printer 2 shifts to step S208.

In step S205, the print data reception control unit 201 judges whether the status of the printer 2 (the printing unit 21) indicates an error on the basis of the status information of the printing unit 21. If the status does not indicate an error, the printer 2 returns to step S204. If the printing unit 21 is in an error state, the printer 2 shifts to step S206. In step S206, the print data reception control unit 201 notifies the print data control unit and the print data transmission control unit that the printing unit 21 is in the error state. Then, the printer 2 shifts to step S207. In step S207, the printer 2 judges whether the error has been removed (coped with). When the error has been removed, the printer 2 returns to step S204. When the error has not been removed, the printer returns to step S207.

In step S208, the print data transmission control unit 203 transmits the print data inputted from the header information analyzing unit 202 to the printing unit 21. Then, the printer 2 shifts to step S209. In step S209, the printing unit 21 prints the image data on a print sheet. The printing unit 21 performs the printing by rotating an image such that a long side of the image is set along a long side of the print sheet and an upper side of the print sheet and an upper side of the image coincide with each other on the basis of print data obtained by applying rotation processing to the image data. Then, the printer 2 proceeds to step S210.

In step S210, the print data reception control unit 201 judges whether all printings in the printing unit 21 have ended on the basis of the status information of the printing unit 21. When all the printings have not ended, the printer 2 returns to step S204. When all the printings have been ended, the printer 2 shifts to step S211. In step S211, the print data reception control unit 201 turns OFF power supply to unnecessary units of the printer 2 and ends the print processing operation.

According to the exemplary embodiment described above, the following advantages are obtained.

(1) In the image processing unit 11, the image display apparatus 1 detects an upper side of an image of image data on the basis of rotation information of the image included in the image data. The printing unit 21 of the printer 2 rotates the image data such that a long side of the image data is set along a long side of a print sheet and prints the image data. Thus, it is possible to print the image data while reducing or preventing the image from lying off the print sheet or being printed upside down. This is effective, for example, in setting an orientation of an address and an orientation of an image in the same direction when image data is printed on a postcard. Thus, it is also possible to reduce or prevent wasteful use of print sheets.

(2) When a user adds rotation instructing information of an image obtained by rotating image data, the image processing unit 11 detects an upper side of the image of the image data on the basis of the rotation instructing information instead of rotation information of the image included in the original image data. The printing unit 21 of the printer 2 rotates the image data such that a long side of the image data is set along a long side of a print sheet and prints the image data. Thus, an image, the image data of which is rotated by the user, can be printed without lying off the print sheet.

### Second Exemplary Embodiment

A second exemplary embodiment will be hereinafter explained.

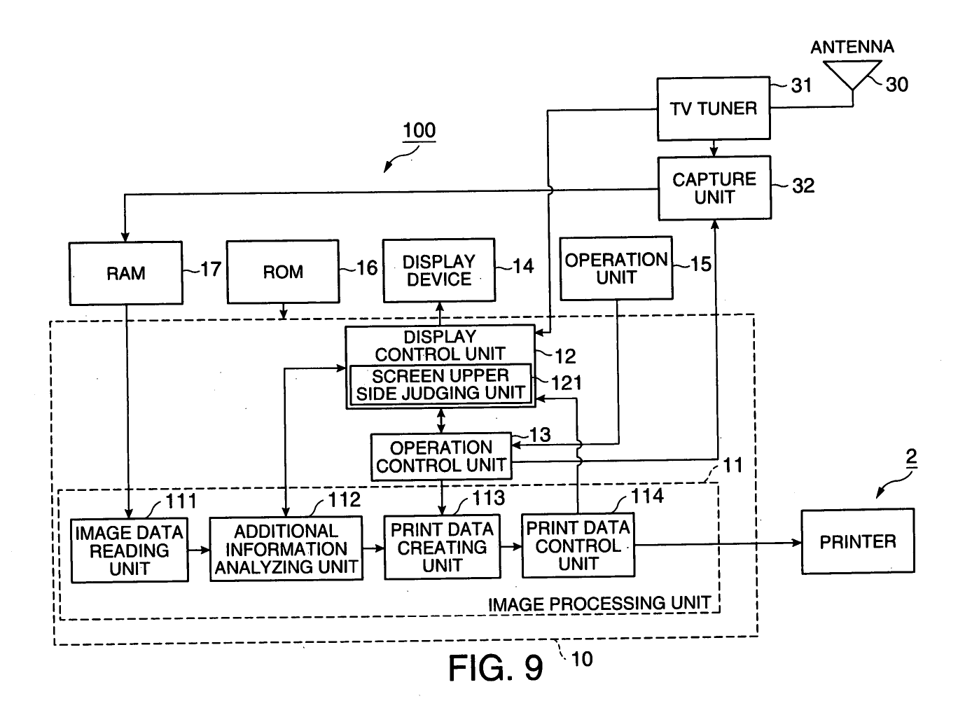

The second exemplary embodiment is an exemplary embodiment in which an image display apparatus 100 incorporating a television receiving function is constituted as an image display apparatus constituting an image processing system. In the second exemplary embodiment, as shown in FIG. 9, the image display apparatus 100 has the same basic structure as the image display apparatus in the first exemplary embodiment except that units constituting the television receiving function (an antenna 30, a TV tuner 31, and a capture unit 32) are arranged. Components corresponding to those in FIG. 1 are denoted by the identical reference numerals and detailed explanations of the components are omitted. In addition, elements and operations other than the television receiving function are the same as those in the first exemplary embodiment and explanations of the constitutions and the operations are also omitted.

FIG. 9 is a schematic showing a structure of an image processing system according to the second exemplary embodiment. In FIG. 9, the image processing system includes the image display apparatus 100 and the printer 2 serving as a printing apparatus. The image display apparatus 100 includes the CPU 10, the display device 14, the operation unit 15, the ROM 16, the RAM 17, the antenna 30 serving as an antenna for television broadcast reception, the television tuner (TV tuner) 31, and the capture unit 32. Note that, when the CPU 10 executes a control program and various application programs stored in the ROM 16, the image processing unit 11, the display control unit 12, and the operation control unit 13 are established.

The TV tuner 31 performs wavelength selection, demodulation, and the like for a broadcast signal (a video signal) received by the antenna 30. When a video, which a user desires to print, is displayed on the display device 14, the user operates a [Capture] key (not shown) of the operation unit 15, whereby the capture unit 32 captures image data of the video as a still image. The RAM 17 stores the image data captured by the capture unit 32 (a capture image). The display control unit 12 applies required signal processing necessary for reproducing the video to the video signal inputted from the TV tuner 31. The video signal subjected to the signal processing is outputted to the display device 14. It is possible to perform the capture operation continuously for plural times. The RAM 17 has a storage capacity capable of storing plural images.

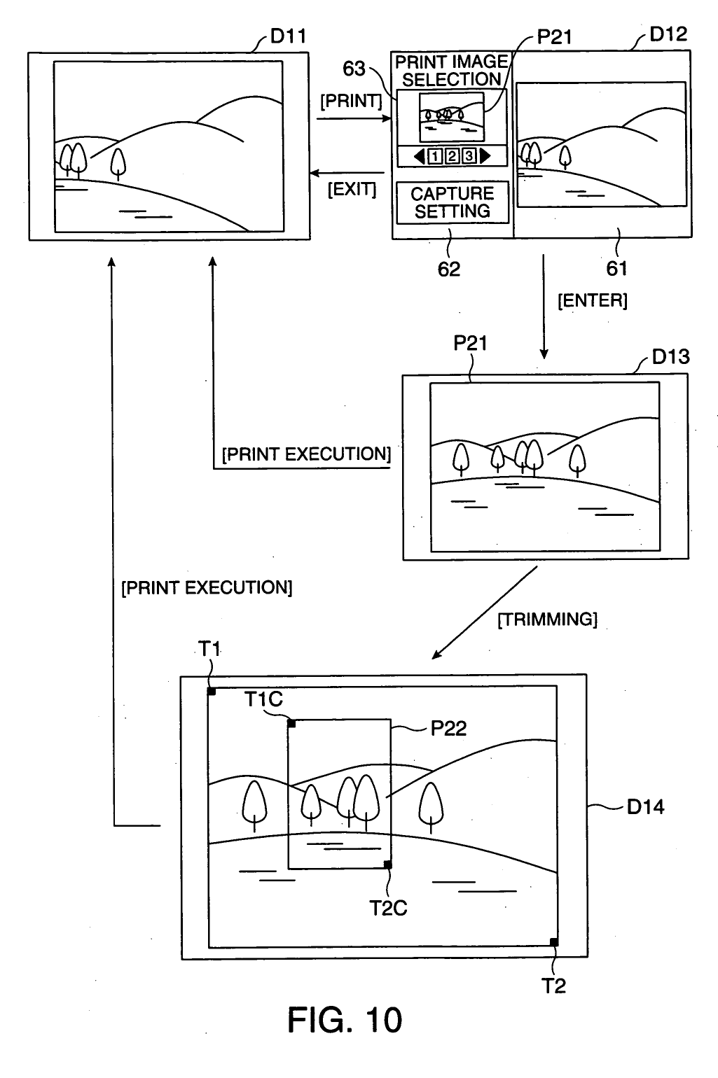

FIG. 10 is a schematic showing an example of a display screen in the capture operation.

A display screen D11 shows a state in which a video of a broadcast signal (a TV screen) is displayed on the display device 14. The video of the broadcast signal is displayed on the entire display device 14. When a video, which a user desires to print, is displayed on a display screen of the display screen D11, if the user operates the [Print] key of the operation unit 15, the display screen D11 shifts to a display screen D12.

On the display screen D12, two screens, a TV screen 61 and a capture setting screen 62, are displayed. The capture image captured by the [Capture] key operation is displayed on the capture setting screen 62. The user can display plural capture images on the capture screen 62 in order with operation of the [Right] and [Left] keys of the operation unit 15 and select a capture image to be printed.

When the [Enter] key of the operation unit 15 is operated in a display state of the display screen D12, the display screen D12 shifts to a display screen D13 and the capture image displayed on the capture screen 63 of the display screen D12 is displayed on the entire display screen of the display device 14. In this state, it is possible to rotate an image in the display with the [R, Rotate] Key or the [L, Rotate] key. When the image is rotated, rotation instructing information is added to the image data. Then, when the [Print execution] key of the operation unit 15 is operated, the printer 2 prints the selected capture image on a print sheet. At this point, when the rotation instructing information is added to the image, the image is directed in an orientation according to the information. When the printing of the capture image ends, the display screen shifts from the display screen D13 to the display screen D11. Thus, the user can learn that the printing has ended.

The image processing system can perform trimming for a display screen. For the trimming, when the user operates the [Trimming] key of the operation unit 15 in an image display state of the display screen D13, the display screen shifts to a display screen D14. On the display screen D14, marks T1 and T2 for performing trimming operation are displayed at two screen corners of the displayed image. The trimming is performed by moving the marks T1 and T2 to positions on the diagonally opposed display screen of an image that the user desires to apply the trimming.

As trimming operation, first, the user moves the mark T1 to a position TIC, to which the user desires to apply the trimming, with operation of the [Up], [Down], [Right], and [Left] keys of the operation unit 15. Then, when the user operates the [Trimming] key of the operation unit 15, a position (screen coordinates) of the mark T1 is recognized and, at the same time, it becomes possible to perform moving operation for the mark T2. As the moving operation for the mark T2, as in the moving operation for the mark T1, the user operates the [Up], [Down], [Right], and [Left] keys of the operation unit 15 to move the mark T2 to, for example, a position T2C and operates the [Trimming] key. Then, a position of the position T2C is recognized and a rectangular image P22 having the position TIC and the position T2C as diagonally opposed corners, is subjected to the trimming. Note that it is possible to rotate and display an image subjected to the trimming as required.

The image upper side judging unit 121 uses Trimming information subjected to the trimming operation (screen coordinates of the positions T1C and T2C) for judgment of an upper side of an image concerning whether an image upper side of the image data subjected to the trimming is a short side or a long side. A result of the judgment is inputted to the additional information analyzing unit 112 together with presence or absence of the rotation display and the like. After that, image processing same as that in the first exemplary embodiment is performed.

When the [Print execution] key of the operation unit 15 is operated in this display state of the display screen D14, the printer 2 prints the selected capture image on a print sheet. When the printing of the capture image ends, the display screen shifts from the display screen D13 to the display screen D11. Note that, it is possible to return to the display screen D13 by pressing the [Trimming] key for a long time on the display screen D14 during the trimming operation.

According to this exemplary embodiment, an image is rotated and printed such that a long side of a video (a TV screen) of a captured broadcast signal or image data subjected to trimming, is set along a long side of a print sheet and an upper side of the print sheet and an upper side of the image coincide with each other. Thus, it is possible to print an image while reducing or preventing the image from lying off the print sheet or being printed upside down.

Other exemplary modifications will be described below.

(First Exemplary Modification)

In the explanation of the first exemplary embodiment, the external storage 3 (the reader writer device for a card medium storing image data of a digital camera) is connected to the image display apparatus 1. In the explanation of the second exemplary embodiment, the image display apparatus 100 incorporates a television receiving function. However, it is also possible that an image display apparatus incorporates the television receiving function and the external storage 3 is connected to the image display apparatus.

(Second Exemplary Modification)

The image processing system may be applied to an image display apparatus with a printer or may be applied to an image display apparatus and a printer that are separately provided and are connected by a communication cable or the like (or by radio).

(Third Exemplary Modification)

The names and the number of the various operations keys provided in the operation unit 15 may be set desirably. As to the operation unit 15, a remote control receiving unit may be provided in the image display apparatus 1 with a remote control transmitter separate from the image display apparatus 1 as an operation unit.

(Fourth Exemplary Modification)

The rotation instruction information may be given as display for attaching marks in positions on an image rather than rotating the image on a screen of the display device.

(Fifth Exemplary Modification)

The detection of an orientation of an image is not limited to the detection of an upper side of the image and may be detection of other sides (a lower side, a right side, etc.) of the image. In addition, rotation information added to image data may be information on the lower side, the right side, and the like of the image or may be information using a position relation of respective apexes. Moreover, the rotation information may be information on a rotation angle or the like with respect to information that is added once.

### Sixth Exemplary Embodiment

A printing direction of a print sheet in the printer may be a horizontal direction (a direction with a long side of the print sheet set as an upstream side of the printing direction). In this case, in FIGS. 4B and 5B, the image is rotated such that the upper side α changes to the side β. In addition, a reference of an orientation of the print sheet does not have to be the upstream side in the printing direction but may be a downstream side or any one of the sides in a lateral direction.

(Seventh Exemplary Modification)

It is also possible that print data obtained by rotating image data is generated on the image display apparatus side and the generated print data is transmitted to the printer.

(Eighth Exemplary Modification)

The printing unit of the printer may be a printer that can set the top and the bottom of a print sheet.

1. An image processing system, comprising:
an image display apparatus that includes a display unit that displays an image; and a first image control unit that creates image data for printing to be outputted to the printer, the image display apparatus performing image processing for image data; and a printer that outputs an image based on the image data to a print medium, the printer including a second image control unit; and a printing unit;
in printing the image displayed on the display unit, the image processing system setting an orientation of the image to be printed such that the orientation is appropriate with respect to an orientation of the print medium defined by the printer.

2. The image processing system according to claim 1, the image data being inputted from the outside and, when orientation information is added to the image data, a reference of the orientation of the image to be printed being set as the orientation information.

3. The image processing system according to claim 1, the reference of the orientation of the image to be printed being set as the orientation of the image displayed on the display unit.

4. The image processing system according to claim 1, the image data being inputted from the outside and, when orientation information added to the image data and the orientation of the image displayed on the display unit do not coincide with each other, the orientation of the image, which is displayed on the display unit, being preferentially used as a reference of the orientation of the image to be printed.

5. The image processing system according to claim 1, the first image control unit adding additional information, with which the printer recognizes the orientation of the image to be printed, to the image data to print and the second image control unit adjusting the orientation of the image to be printed on a basis of the additional information added to the image data to print and causing the printing unit to print the image.

6. The image processing system according to claim 5, when orientation information is added to the image data and the orientation information and the orientation of the image displayed on the image display unit do not coincide with each other, the first image control unit replacing the orientation information with a content suited to the orientation of the image displayed on the display unit and creating image data for printing.

7. The image processing system according to claim 1, the first image control unit changing the orientation of the image data such that the orientation of the image to be printed is appropriate with respect to the orientation of the print medium defined by the printer and creating image data for printing.

8. The image processing system according to claim 1, the second image control unit arranging an image such that a shape of the image to be printed and a shape of the print medium coincide with each other and adjusting the orientation of the image to be printed on a basis of the image data for printing to cause the printing unit to print the image.

9. The image processing system according to claim 8, when the image is arranged such that a long side of the image is set along a long side of the print medium, if a top-to-bottom direction of the image based on the image data for printing and a print direction coincide with each other, the second image control unit rotating the image such that the long side of the image is set along the long side of the print medium and an upper side of the print medium defined by the printer and an upper side of the image coincide with each other and causing the printing unit to print the image.

10. An image display apparatus, comprising:
the image processing system according to claim 1.

11. A printer, comprising:
the image processing system according to claim 1.

12. A printing method of outputting image data to a print medium, comprising:
recognizing an orientation of the print medium defined by a printer;
recognizing an orientation of an image based on image data;
adjusting an orientation of an image to be printed such that the orientation of the image to be printed is appropriate with respect to the orientation of the print medium defined by the printer; and
outputting the image to the print medium in the adjusted orientation.
